(19) United States
(12) Patent Application Publication
(10) Pub. No.: US 2026/0353298 A1
(43) Pub. Date: Nov. 5, 2026

(54) LOW-POWER-CONSUMPTION DEVICE INTERCONNECTION SYSTEM AND METHOD, AND STORAGE MEDIUM

(71) Applicants: BOE Technology Group Co., Ltd., Beijing (CN); Beijing BOE Technology Development Co., Ltd., Beijing (CN)

(72) Inventors: Rongzuo ZHANG, Beijing (CN); Jun YANG, Beijing (CN); Hongtao GUAN, Beijing (CN); Xiaotian JIANG, Beijing (CN); Tao LI, Beijing (CN)

(21) Appl. No.: 19/487,424

(22) PCT Filed: May 27, 2024
(86) PCT No.: PCT/CN2024/095394

§ 371 Date: Nov. 24, 2025

(30) Foreign Application Priority Data
May 30, 2023 (CN) 202310628051.8

(51) Int. Cl. H04W 52/02; H04L 43/0829; H04W 24/08; H04W 88/16

(52) U.S. Cl. CPC H04W 52/0238; H04L 43/0835; H04W 24/08; H04W 88/16

(57) ABSTRACT

The present disclosure belongs to the technical field of communications, and provides a low-power-consumption device interconnection system and method, and a storage medium. The low-power-consumption device interconnection system includes a gateway and a terminal. The terminal is configured to send a first data packet to the gateway, receive a packet loss rate fed back from the gateway, and judge whether the packet loss rate is greater than the first preset threshold; and determine, based on a judgment result and a current transmitting power for sending the first data packet, a transmitting power for sending a next first data packet. The gateway is configured to receive and count first data packets, and, each time a count result reaches a second preset threshold, calculate a packet loss rate and reset the count result; and send the packet loss rate to the terminal.

### CROSS-REFERENCE TO RELATED APPLICATIONS

The present disclosure claims priority from Chinese patent application No. 202310628051.8 filed on May 30, 2023, the disclosure of which is incorporated hereby by reference.

### TECHNICAL FIELD

The present disclosure belongs to the technical field of communications, and specifically relates to a low-power-consumption device interconnection system and method, and a storage medium.

### BACKGROUND

With the continuous development of the internet technology, application scenarios such as internet of things acquisition and control terminals adopting wireless communication can be seen everywhere in daily life. However, current wireless network systems transmit data with the same (or default) transmitting power regardless of the specific working conditions of terminals. In other words, data is transmitted with the same transmitting power regardless of the state of the terminal (for example, the data volume, the packet loss rate, the network speed, and the like), which may increase unnecessary power consumption, and pose a higher requirement on wireless communication devices powered by batteries.

### SUMMARY

To solve at least one of the technical problems in the existing art, the present disclosure provides a low-power-consumption device interconnection system and method, and a storage medium.

In a first aspect, a technical solution adopted to solve the technical problem of the present disclosure is a low-power-consumption device interconnection system, including a gateway and a terminal, wherein
the terminal is configured to send a first data packet to the gateway, receive a packet loss rate fed back from the gateway, and judge whether the packet loss rate is greater than a first preset threshold; and determine, based on a judgment result and a current transmitting power for sending the first data packet, a transmitting power for sending a next first data packet; and
the gateway is configured to receive and count first data packets, and, each time a count result reaches a second preset threshold, calculate a packet loss rate and reset the count result; and send the packet loss rate to the terminal.

In some embodiments, the terminal includes a communication module and a controller;
the communication module is configured to send a first data packet received from the controller to the gateway; and receive the packet loss rate fed back from the gateway, and send the packet loss rate to the controller; receive a transmitting power to be configured for sending the first data packet, and send a next first data packet according to a currently configured transmitting power; and
the controller is configured to send a first data packet to be transmitted to the communication module; and receive the packet loss rate from the communication module, and judge whether the packet loss rate is greater than the first preset threshold; and determine, based on a judgment result and a current transmitting power for sending the first data packet, a transmitting power for sending a next first data packet, and configure the transmitting power for sending the next first data packet to the communication module.

In some embodiments, the controller includes a data transmission module and a first power determination module;
the data transmission module is configured to send a first data packet to be transmitted to the communication module;
the first power determination module is configured to: receive the packet loss rate; under the condition that the packet loss rate is less than or equal to the first preset threshold, reduce, according to a preset first power adjustment amplitude, the transmitting power for sending the current first data packet to serve as the transmitting power for sending the next first data packet, and configure the transmitting power for sending the next first data packet to the communication module; and under the condition that the packet loss rate is greater than the preset threshold, increase, according to a preset second power adjustment amplitude, the transmitting power for sending the current first data packet to serve as the transmitting power for sending the next first data packet, and configure the transmitting power for sending the next first data packet to the communication module.

In some embodiments, the data transmission module is further configured to: determine a data transmission mode in response to a data transmission request and according to a first data volume of the first data packet to be transmitted; and send the first data packet according to the determined data transmission mode.

In some embodiments, the data transmission module includes a mode determination unit and a data transmission unit;
the mode determination unit is configured to: determine, based on the first data volume of the first data packet, a second data volume of the first data packet after compression; determine a comparison result of energy consumption between compression transmission and non-compression transmission based on the first data volume, the second data volume, a first average current for non-compression transmission of the first data packet and a second average current for compression-transmission of the first data packet; and determine the data transmission mode to be a compression mode or a non-compression mode according to the comparison result; and
the data transmission unit is configured to send the first data packet according to the determined data transmission mode.

In some embodiments, the energy consumption for the compression transmission is A1×(a+b×N1)+A2×(c+d×n1), and the energy consumption for the non-compression transmission is A1×(a+b×n1), where A1 represents the first average current for non-compression transmission of the first data packet, A2 represents the second average current for compressing the first data packet, n1 represents the first data volume, (a+b×n1) represents transmission time for the non-compressed first data packet, (a+b×N1) represents transmission time for the compressed first data packet, N1 represents the second data volume, (c+d×n1) represents time for compressing the first data packet, and a, b, c, and d are preset coefficients, and wherein
the mode determination unit is further configured to: under the condition that energy consumption A1×(a+b×N1)+A2×(c+d×n1) for the compression transmission is greater than energy consumption A1×(a+b×n1) for the non-compression transmission, determine the transmission mode to be a non-compression mode; and under the condition that energy consumption A1×(a+b×N1)+A2×(c+d×n1) for the compression transmission is not greater than energy consumption A1×(a+b×n1) for the non-compression transmission, determine the transmission mode to be a compression mode.

In some embodiments, the gateway is further configured to: determine, based on a third data volume of a second data packet to be transmitted, a fourth data volume of the second data packet after compression; determine, based on the third data volume, the fourth data volume, a third average current when the terminal receives data, and a fourth average current when the terminal decompresses data, a comparison result of energy consumption between the terminal receiving compressed data and the terminal receiving non-compressed data; determine the data transmission mode to be a compression mode or a non-compression mode based on the comparison result; and send the second data packet to the terminal according to the determined data transmission mode.

In some embodiments, the energy consumption for the terminal receiving compressed data is A3×(e+f×N2)+A4×(g+h×N2), and the energy consumption for the terminal receiving non-compressed data is A3×(e+f×n2), where A3 represents the third average current when the terminal receives data, A4 represents the fourth average current when the terminal decompresses data, n2 represents the third data volume, N2 represents the fourth data volume, (e+f×N2) represents time for the terminal receiving data, (g+h×N2) represents time for the terminal decompressing data, (e+f×n2) represents time for the terminal receiving data, and e, f, g, and h represent preset parameters, and wherein
the gateway is further configured to: under the condition that the energy consumption A3×(e+f×N2)+A4×(g+h×N2) for the terminal receiving compressed data is greater than the energy consumption A3×(e+f×n2) for the terminal receiving non-compressed data, determine the data transmission mode to be a non-compression mode; and under the condition that the energy consumption A3×(e+f×N2)+A4×(g+h×N2) for the terminal receiving compressed data is not greater than the energy consumption A3×(e+f×n2) for the terminal receiving non-compressed data, determine the data transmission mode to be a compression mode.

In some embodiments, the terminal includes a communication module and a controller; the controller further includes a second power determination module;
the communication module is configured to: establish communicative connection with the gateway in response to an instruction to establish connection with the gateway; and send the received gateway signal intensity and WiFi signal intensity to the second power determination module;
the second power determination module is configured to: receive the gateway signal intensity and the WiFi signal intensity, and determine, based on a preset initial transmitting power, the gateway signal intensity, and the WiFi signal intensity, a transmitting power for the terminal sending a first first data packet; and
the gateway is further configured to receive a communicative connection request, send an instruction to establish the connection to the communication module, and feed back the gateway signal intensity and the WiFi signal intensity to the communication module.

In some embodiments, the second power determination unit includes a first coarse tuning subunit and a second coarse tuning subunit;
the first coarse tuning subunit is configured to determine a coarse power for the terminal sending the first data packet according to a correspondence relationship between transmitting powers and signal intensities of the terminal for sending the first data packet, the preset initial transmitting power for the terminal sending the first data packet, the gateway signal intensity, and the WiFi signal intensity; and
the second coarse tuning subunit is configured to determine, according to a boot time of the terminal, the coarse power for the terminal sending the first data packet, the gateway signal intensity, and the WiFi signal intensity, a transmitting power for the terminal sending a first first data packet.

In some embodiments, the second coarse tuning subunit determines the coarse power for the terminal sending the first first data packet by:

$${P}_{1} = {P}_{0} \times {( \frac{RSSI\_AP}{RSSI\_STA} )}^{2}$$

where P₁ represents the transmitting power for the terminal sending the first first data packet; P₀ represents the initial transmitting power for the terminal sending the first data packet; RSSI_AP represents the gateway signal intensity; and RSSI_STA represents the WiFi signal intensity.

In some embodiments, the second coarse tuning subunit determines the transmitting power for the terminal sending the first first data packet by:

$${P}_{1} = \frac{{P}_{2}}{2}$$

where P₁ represents the transmitting power for the terminal sending the first first data packet; and P₂ represents the coarse power.

In some embodiments, the second coarse tuning subunit is further configured to: after the terminal is powered on and the boot time of the terminal is not reached, adjust the coarse power for the terminal sending the first data packet for multiple times, and take each adjusted coarse power for the terminal sending the first data packet as the coarse power to be adjusted for the terminal sending the first data packet; when the boot time of the terminal is reached, take a last adjusted coarse power for the terminal sending the first data packet as the transmitting power for the terminal sending the first first data packet; and
wherein the second coarse tuning subunit is further configured to: judge, in each adjustment of the coarse power, whether the WiFi signal intensity is greater than the gateway signal intensity; if the WiFi signal intensity is greater than the gateway signal intensity, adjust the coarse power of the first data packet sent from the terminal according to a preset algorithm, so that the adjusted coarse power of the first data packet sent from the terminal is less than the coarse power of the first data packet sent from the terminal before adjustment; and if the WiFi signal intensity is less than or equal to the gateway signal intensity, take a current coarse power for the terminal sending the first data packet as the coarse power to be adjusted for the terminal sending the first data packet.

In some embodiments, the terminal further includes a mode determination module; and one heartbeat cycle of the terminal includes one wakeup cycle and one sleep cycle; and
the mode determination module is configured to: in response to an end of a wakeup cycle, determine, according to a preset fifth average current in a light sleep mode, a preset sixth average current when the gateway is scanned for connection, a preset seventh average current in a deep sleep mode, a duration of the sleep cycle, and a connection duration of the terminal scanning the gateway for connection, a sleep mode of a sleep cycle to be entered by the terminal as a light sleep mode or a deep sleep mode; and enter a sleep state according to the determined sleep mode until a wakeup cycle begins.

In some embodiments, energy consumption for the terminal entering light sleep is A5×t8, and energy consumption for the terminal entering deep sleep is (t8−t7)×A7+t7×A6, where A5 represents the preset fifth average current in the light sleep mode, A6 represents the preset sixth average current when the gateway is scanned for connection, A7 represents the preset seventh average current in the deep sleep mode, t8 represents the duration of the sleep cycle, and t7 represents the connection duration of the terminal scanning the gateway for connection, and wherein
the mode determination module is further configured to: under the condition that the energy consumption A5×t8 for the terminal entering the light sleep is greater than the energy consumption (t8−t7)×A7+t7×A6 for the terminal entering the deep sleep, determine that the terminal enters the deep sleep mode; and under the condition that the energy consumption A5×t8 for the terminal entering the light sleep is not greater than the energy consumption (t8−t7)×A7+t7×A6 for the terminal entering the deep sleep, determine that the terminal enters the light sleep mode.

In some embodiments, the terminal is further configured to be operated in the light sleep mode during the wakeup cycle until receiving or sending data according to a preset task in response to a data transceiving request.

In some embodiments, the gateway is further configured to determine a next wakeup cycle of the terminal according to a data volume transmitted by the terminal in unit time and a network speed of the terminal.

In some embodiments, the gateway is further configured to: acquire a predefined minimum data variation in two adjacent transmissions by the terminal; and determine a next wakeup cycle of the terminal based on the minimum data variation, an actual data variation between two adjacent transmissions by the terminal, and a time difference between two adjacent data transmissions.

In a second aspect, an embodiment of the present disclosure further provides a low-power-consumption device interconnection method applied to a low-power-consumption device interconnection system, wherein the low-power-consumption device interconnection system includes a gateway and a terminal; and the low-power-consumption device interconnection method includes:
by the terminal, sending a first data packet to the gateway, receiving a packet loss rate fed back from the gateway, and judging whether the packet loss rate is greater than the first preset threshold; and determining, based on a judgment result and a current transmitting power for sending the first data packet, a transmitting power for sending a next first data packet; and
by the gateway, receiving and counting first data packets, and, each time a count result reaches a second preset threshold, calculate a packet loss rate and reset the count result; and sending the packet loss rate to the terminal.

In a third aspect, an embodiment of the present disclosure further provides a computer-readable non-transitory storage medium, wherein the computer-readable non-transitory storage medium has a computer program stored thereon which, when executed by a processor, cause steps of the low-power-consumption device interconnection method according to the second aspect to be implemented.

### BRIEF DESCRIPTION OF FIGURES

FIG. 1 is a schematic diagram of a low-power-consumption device interconnection system according to an embodiment of the present disclosure;

FIG. 2 is a schematic diagram illustrating information interaction between a gateway and a terminal according to an embodiment of the present disclosure;

FIG. 3 is a schematic diagram illustrating radiant energy of air electromagnetic waves according to an embodiment of the present disclosure;

FIG. 4 is a schematic diagram illustrating information interaction between a gateway and a terminal according to an embodiment of the present disclosure;

FIG. 5 is a flowchart of power fine tuning according to an embodiment of the present disclosure;

FIG. 6a is a flowchart illustrating a first step of power coarse tuning according to an embodiment of the present disclosure; and

FIG. 6b is a flowchart illustrating a second step of power coarse tuning according to an embodiment of the present disclosure.

### DETAILED DESCRIPTION

To clarify the objects, technical solutions and advantages of the embodiments of the present disclosure, the technical solutions in the embodiments of the present disclosure will be clearly and completely described below with reference to the accompanying drawings in the embodiments of the present disclosure. Obviously, the described embodiments are merely some, not all, of the embodiments of the present disclosure. The components in the embodiments of the present disclosure, as generally described and illustrated in the figures herein, could be arranged and designed in a wide variety of different configurations. Therefore, the following detailed description of the embodiments of the present disclosure, provided in the accompanying drawings, is not intended to limit the scope of the present disclosure as claimed, but is merely representative of selected embodiments of the present disclosure. All other embodiments, which can be derived by those skilled in the art from the embodiments of the present disclosure without making any creative effort, shall fall within the protection scope of the present disclosure.

Unless otherwise defined, technical or scientific terms used in the present disclosure are intended to have general meanings as understood by those of ordinary skill in the art to which the present disclosure belongs. The words “first”, “second” and similar terms used in the present disclosure do not denote any order, quantity, or importance, but are used merely for distinguishing different components from each other. Likewise, the words “a”, “an”, or “the” and similar referents do not denote a limitation of quantity, but rather denote the presence of at least one. The word “comprise” or “include” or the like means that the element or item preceding the word contains elements or items that appear after the word or equivalents thereof, but does not exclude other elements or items. The terms “connected” or “coupled” and the like are not restricted to physical or mechanical connection, but may include electrical connection, either direct or indirect. The words “upper”, “lower”, “left”, “right”, or the like are merely used to indicate a relative positional relationship, and when an absolute position of the described object is changed, the relative positional relationship may be changed accordingly.

Reference to “a plurality of or several” in the present disclosure means two or more. The term “and/or” describes an association relationship of associated objects, which may include three relationships; for example, A and/or B may refer to: A alone, A and B, or B alone. The character “/” generally indicates that the former and latter associated objects are in an “or” relationship.

In the existing art, in an application scenario of an internet of things (IoT) type WiFi module (i.e., a terminal), the transmitting power is an important factor for determining the overall power consumption of the device. The transmitting power of the terminal may be manually adjusted. However, in the face of a complex electromagnetic environment, the manual adjustment of transmitting power cannot meet the requirement for real-time adjustment of power. As a result, if the terminal still sends data with the final fixed transmitting power adjusted manually in operation, the fixed transmitting power often fails to enable low-power-consumption operation of the terminal in different working states when the working state of the terminal is constantly changed in real-time operation of the terminal. In addition, current algorithms allowing low-power optimization are generally complex, and no unified and convenient WiFi low-power-consumption scheme has been proposed. For example, the conventional schemes for reducing power consumption are mostly implemented at a controlling level (server), and there is no scheme based on communication.

In view of this, an embodiment of the present disclosure provides a low-power-consumption device interconnection system and method, and a storage medium, which substantially eliminate one or more of the problems due to limitations and defects in the existing art.

In an embodiment of the present disclosure, the low-power-consumption device interconnection system includes a gateway and a terminal. The terminal is configured to send a first data packet to the gateway, receive a packet loss rate fed back from the gateway, and judge whether the packet loss rate is greater than the first preset threshold; and determine, based on a judgment result and a current transmitting power for sending the first data packet, a transmitting power for sending a next first data packet. The gateway is configured to receive and count first data packets, and, each time a count result reaches a second preset threshold, calculate a packet loss rate and reset the count result; and send the packet loss rate to the terminal.

It should be noted that since autonomous tailoring and extension of a wireless communication protocol is difficult to implement, the transmitting power of the terminal is dynamically adjusted at an application level (terminal) in the embodiments of the present disclosure, to ensure a continuous low-power-consumption state of the terminal. Specifically, the terminal judges whether to adjust its current transmitting power mainly by receiving a packet loss rate fed back from the gateway (i.e., a protocol layer). It should be noted that the packet loss rate refers to a probability of lost first data packets calculated by the gateway while the terminal continuously sends first data packets to the gateway. The packet loss rate is related to the transmitting power of the terminal, and a higher packet loss rate indicates a lower transmitting power. Therefore, the terminal adjusts the current transmitting power for sending a first data packet based on the actual packet loss rate. For example, in the case that the judgment result indicates a lower packet loss rate, the transmitting power can be appropriately reduced to reduce the system power consumption. In addition, the gateway may be configured to calculate the packet loss rate only when a certain number of first data packets have been received, so that unnecessary power consumption increased by frequently counting the packet loss rate is avoided, and thus, unnecessary power consumption increased by frequently adjusting the transmitting power is avoided.

The following provides a detailed description of the low-power-consumption device interconnection system provided in the embodiments of the present disclosure.

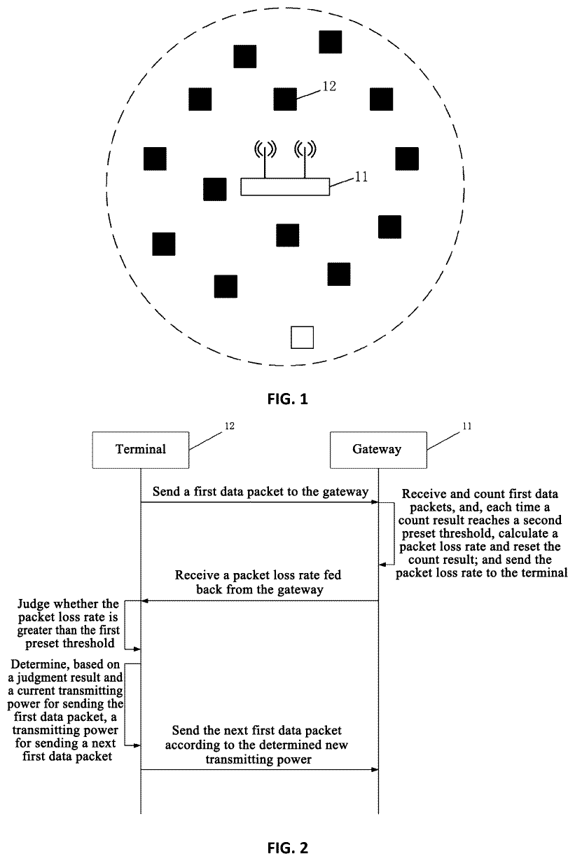

FIG. 1 is a schematic diagram of a low-power-consumption device interconnection system according to an embodiment of the present disclosure. As shown in FIG. 1, the low-power-consumption device interconnection system includes a gateway 11 and a terminal 12. The low-power-consumption device is, for example, a gateway 11 and/or a terminal 12. The gateway 11 may be understood as a wireless access point (AP), or “hotspot”, which can be connected by a plurality of terminals 12 to establish a center of a star topology network, typically in the form of a router or customer premises equipment (CPE). The terminal 12 may be understood as a WiFi module, which is a WiFi wireless terminal STA.

FIG. 2 is a schematic diagram illustrating information interaction between a gateway 11 and a terminal 12 according to an embodiment of the present disclosure. As shown in FIG. 2, the terminal 12 is configured to send a first data packet to the gateway 11, receive a packet loss rate fed back from the gateway 11, and judge whether the packet loss rate is greater than the first preset threshold; and determine, based on a judgment result and a current transmitting power for sending the first data packet, a transmitting power for sending a next first data packet. The gateway 11 is configured to receive and count first data packets, and, each time a count result reaches a second preset threshold, calculate a packet loss rate and reset the count result; and send the packet loss rate to the terminal 12.

Illustratively, the gateway 11 is linked to the terminal 12 via a TCP/IP protocol, and the terminal 12 establishes communicative connection with the gateway 11 during a power-on and boot-up stage of terminal 12. Thereafter, the gateway 11 confirms the connection; and the TCP/IP protocol of the link layer, which has a mechanism for counting the packet loss rate, may calculate and feed back the packet loss rate according to a count result of the received first data packets. For example, the mechanism for calculating the packet loss rate is to calculate the packet loss rate once every N packets. In other words, each time the gateway 11 receives N first data packets, the TCP/IP protocol calculates the packet loss rate once and feeds back the packet loss rate to the terminal 12.

The first preset threshold may be a maximum acceptable packet loss rate; or, the first preset threshold may be a maximum acceptable packet loss rate with redundancy, and may be set according to the actual application scenario, which is not specifically limited in the embodiments of the present disclosure. The terminal 12 is configured to adjust, based on a judgment result about whether the packet loss rate is greater than the first preset threshold, the current transmitting power for sending the first data packet, and use the adjusted transmitting power as the transmitting power for sending a next first data packet. Illustratively, if the judgment result indicates that the packet loss rate is less than or equal to the first preset threshold, the current transmitting power for sending the first data packet is reduced so that the transmitting power, and thus the power consumption, of the terminal 12 for sending subsequent first data packets are reduced, thereby achieving low power consumption of the terminal 12.

It should be noted that, in practical application scenarios, the terminal 12 may fail to receive signals due to its susceptibility to external factors (such as accidental displacement or tiny electromagnetic interference), causing packet loss (in other words, packet loss is unavoidable). The TCP/IP protocol has a first data packet retransmission mechanism, which means that packets lost in air will be retransmitted, so the system allows a certain packet loss rate caused by external factors, with a preset maximum packet loss rate. When the packet loss rate counted by the gateway 11 is greater than the maximum packet loss rate, it indicates that the data transmission through the terminal 12 is affected not only by external factors but also a reduced transmitting power. Therefore, the transmitting power can be appropriately increased to balance the air packet loss rate.

It is known that the packet loss rate is related to the transmitting power, and the packet loss rate can probably be increased by reducing the transmitting power. When the packet loss rate remains less than the first preset threshold, the transmitting power is continuously decreased to continuously increase the packet loss rate, and when the packet loss rate is greater than the first preset threshold, the current transmitting power for sending the first data packet can be appropriately increased to balance a next count packet loss rate. Alternatively, when the packet loss rate is greater than the first preset threshold, if the packet loss rate is a packet loss rate with redundancy, the current transmitting power for sending the first data packet can be further reduced until the packet loss rate breaks through a preset lower limit, and then the current transmitting power for sending the first data packet is appropriately increased to balance a next count packet loss rate.

In some embodiments, the terminal STA includes a controller and a communication module. The controller may be, for example, a microcontroller unit (MCU), and the communication module may be, for example, a radio frequency integrated circuit (IC). The radio frequency IC is connected to the controller via a bus. The radio frequency IC establishes communicative connection with the gateway 11, so that the controller establishes communication connection with the gateway 11 through the radio frequency IC.

In the power-on and boot-up stage of the terminal 12, the controller controls the radio frequency IC to establish the communicative connection with the gateway 11.

The communication module is configured to send the received first data packet to the gateway 11; receive the packet loss rate fed back from the gateway 11, and send the packet loss rate to the controller; and receive a transmitting power to be configured to send a next first data packet according to the currently configured transmitting power.

The controller is configured to send a first data packet to be transmitted to the communication module; and receive the packet loss rate, and judge whether the packet loss rate is greater than the first preset threshold; and determine, based on a judgment result and a current transmitting power for sending the first data packet, a transmitting power for sending a next first data packet, and configure the transmitting power for sending the next first data packet to the communication module.

Illustratively, if the judgment result indicates that the packet loss rate is less than or equal to the first preset threshold, the controller instructs the communication module to reduce the current transmitting power for sending the first data packet, so that the transmitting power, and thus the power consumption, of the radio frequency IC for sending subsequent first data packets are reduced, thereby achieving low power consumption of the radio frequency IC.

In some embodiments, the controller includes a data transmission module and a first power determination module. The data transmission module is configured to send a first data packet to be transmitted to the communication module. The first power determination module is configured to receive the packet loss rate; under the condition that the packet loss rate is less than or equal to the first preset threshold, reduce, according to a preset first power adjustment amplitude, the transmitting power for sending the current first data packet to determine a transmitting power for sending a next first data packet, and configure the transmitting power for sending the next first data packet to the communication module; and under the condition that the packet loss rate is greater than the preset threshold, increase, according to a preset second power adjustment amplitude, the transmitting power for sending the current first data packet to determine a transmitting power for sending a next first data packet, and configure the transmitting power for sending the next first data packet to the communication module.

The first and second power adjustment amplitudes here may be parameters set according to the practical applications, performance of the terminal 12, and experience, which are not specifically limited in the embodiments of the present disclosure. The first and second power adjustment amplitudes here may be the same or different.

Taking the case where the first and second power adjustment amplitudes are the same and both equal to 0.01 W as an example for illustration, under the condition that the packet loss rate is less than or equal to the first preset threshold, the current transmitting power for sending the first data packet is reduced by 0.01 W and then used as a transmitting power for sending a next first data packet, and configured to the radio frequency IC through the bus so that the transmitting power, and thus the power consumption, of the radio frequency IC for sending subsequent first data packets are reduced, thereby achieving low power consumption of the radio frequency IC. Under the condition that the packet loss rate is greater than the first preset threshold, the current transmitting power for sending the first data packet is increased by 0.01 W and then used as a transmitting power for sending a next first data packet, and configured to the radio frequency IC through the bus.

Further, the first power determination module is further configured to, under the condition that the packet loss rate is greater than the first preset threshold, update the second preset threshold and send the updated second preset threshold to the gateway 11, so that the gateway 11 re-customizes a packet loss rate statistical mechanism based on the updated second preset threshold. Here, the updated second preset threshold is greater than the second preset threshold before updating. For example, the second preset threshold before updating is 1000, and the updated second preset threshold is 10000. Illustratively, the gateway 11 is configured to receive the updated second preset threshold and adjust the packet loss rate statistical mechanism. The adjusted packet loss rate statistical mechanism may include, for example: receiving and counting first data packets, and, each time a count result reaches the updated second preset threshold, calculate a packet loss rate and reset the count result; and sending the packet loss rate to the terminal 12.

In some embodiments, the terminal 12 sends/receives data to/from the gateway 11 via the radio frequency IC. The terminal 12 records a first data volume corresponding to each first data packet; and in the data transmission process, the duration of wireless communication (WiFi communication) can be reduced by compressing the first data packet, so that the power consumption of the radio frequency IC is reduced.

Specifically, the data transmission module is specifically configured to determine a data transmission mode in response to a data transmission request and according to a first data volume of the first data packet to be transmitted; and send the first data packet according to the data transmission mode.

Illustratively, under the condition that the first data volume does not reach the preset data volume, the data transmission mode is determined as a non-compression mode; and the first data packet is transmitted in the non-compression mode. Under the condition that the first data volume reaches the preset data volume, the data transmission mode is determined as a compression mode; and the first data packet is transmitted in the compression mode. Here, the preset data volume is set in advance. Although the first data packet may be compressed to save the duration of data transmission and reduce the power consumption of the terminal 12, it may also increase the energy consumption of the terminal 12. Therefore, the preset data volume should be set such that: a transmission energy consumption Q1 in a non-compressed state of the first data packet corresponding to the preset data volume is less than the sum of a transmission energy consumption Q2 in a compressed state of the first data packet corresponding to the preset data volume and an energy consumption Q3 in the compression process of the first data packet corresponding to the preset data volume, that is, Q1<(Q2+Q3).

In this embodiment, an optimal power consumption policy (the compression or non-compression mode) can be reasonably calculated from the first data volume of the first data packet to be transmitted, so that the first data packet can be sent according to the optimal power consumption policy, and thus the power consumption of the terminal 12 sending data can be reduced. In addition, based on the comparison result of the first data volume and the preset data volume, the data transmission mode can be determined more quickly, thereby improving the data transmission efficiency.

In some embodiments, based on the above embodiments, the data transmission module includes a mode determination unit and a data transmission unit. The mode determination unit is configured to determine a data transmission mode according to the first data volume of the first data packet. The data transmission unit is configured to send the first data packet according to the data transmission mode.

Specifically, the mode determination unit is specifically configured to determine, based on the first data volume of the first data packet, a second data volume of the first data packet after compression; determine a comparison result of energy consumption between compression transmission and non-compression transmission based on the first data volume, the second data volume, a first average current for non-compression transmission of the first data packet and a second average current for compression-transmission of the first data packet; and determine the data transmission mode to be a compression mode or a non-compression mode according to the comparison result. The data transmission unit is configured to send the first data packet according to the determined data transmission mode, i.e., the compression mode or non-compression mode.

Here, the second data volume obtained by compressing the first data packet may be calculated by a preset compression algorithm.

Illustratively, the data volume of the first data packet in the non-compressed state is a first data volume denoted as n1. If data transmission is performed in the non-compression mode, the data transmission time is t1=a+b×n1, where a and b are coefficients which can be actually measured. The first average current of the terminal 12 for sending data is A1, which can be obtained through a fixed pattern test. In the process of compressing data by the terminal 12, the time for data compression is t2=c+d×n1, where c and d are coefficients which can be actually measured. The second average current for data compression is A2, which can be obtained through a fixed pattern test. The data volume of the first data packet in the compressed state is a second data volume denoted as N1. If data transmission is performed in the compression mode, then the data transmission time is t3=a+b×N1. On this basis, when data is directly sent without compression, the consumed energy is A1×(a+b×n1), and when data is sent after compression, the consumed energy is A1×(a+b×N1)+A2×(c+d×n1). If a comparison result of energy consumption between the compression transmission and the non-compression transmission indicates A1×(a+b×N1)+A2×(c+d×n1)>A1×(a+b×n1), the data transmission mode is determined as a non-compression mode. In contrast, if the comparison result of energy consumption between the compression transmission and the non-compression transmission indicates A1×(a+b×N1)+A2×(c+d×n1)≤A1×(a+b×n1), the data transmission mode is determined as a compression mode.

In this embodiment, an optimal power consumption policy (the compression or non-compression mode) can be reasonably calculated from the first data volume of the first data packet to be transmitted, so that the first data packet can be sent according to the optimal power consumption policy, and thus the power consumption of the terminal 12 sending data can be reduced. In addition, by determining a comparison result of energy consumption between compression transmission and non-compression transmission based on the first data volume, the second data volume, a first average current for non-compression transmission of the first data packet and a second average current for compression-transmission of the first data packet, the data transmission mode can be determined more accurately, thereby achieving low power consumption of the terminal 12.

In some embodiments, similarly to the above data transmission process, when the terminal 12 receives data, the gateway 11 may implement energy consumption calculation of the terminal 12 for receiving data based on a second data packet to be sent, thereby achieving low power consumption of the terminal 12.

The gateway 11 is further configured to determine, based on a third data volume of a second data packet to be transmitted, a fourth data volume of the second data packet after compression; determine, based on the third data volume, the fourth data volume, a third average current when the terminal 12 receives data, and a fourth average current when the terminal 12 decompresses data, a comparison result of energy consumption between the terminal 12 receiving compressed data and the terminal 12 receiving non-compressed data; determine the data transmission mode to be a compression mode or a non-compression mode according to the comparison result; and send the second data packet to the terminal 12 according to the determined data transmission mode, i.e., the compression mode or non-compression mode.

Here, the fourth data volume obtained by compressing the second data packet may be calculated by a preset compression algorithm.

Illustratively, the data volume of the second data packet in the non-compressed state is a third data volume denoted as n2. If the gateway 11 performs data transmission in the non-compression mode, time for the terminal 12 receiving data is t4=e+f×n2, where e and f are coefficients which can be actually measured. The third average current of the terminal 12 for receiving data is A3, which can be obtained through a fixed pattern test, the data volume of the second data packet in the non-compressed state is a third data volume denoted as N2. If the gateway 11 performs data transmission in the compression mode, time for the terminal 12 receiving data is t5=e+f×N2. In the process of decompressing data by the terminal 12, the time for data decompression is t6=g+h×N2, where g and h are coefficients which can be actually measured. The fourth average current of the terminal 12 for decompressing data is A4, which can be obtained through a fixed pattern test. On this basis, when the gateway 11 directly send data without compression, the energy consumed by the terminal 12 receiving data is A3×(e+f×n2). When the gateway 11 sends data after compression, the energy consumed by the terminal 12 receiving data is A3×(e+f×N2)+A4×(g+h×N2). If a comparison result of energy consumption between the terminal 12 receiving compressed data and the terminal 12 receiving non-compressed data indicates A3×(e+f×N2)+A4×(g+h×N2)>A3×(e+f×n2), the data transmission mode is determined as a non-compression mode. In contrast, if the comparison result of energy consumption between the terminal 12 receiving compressed data and the terminal 12 receiving non-compressed data indicates A3×(e+f×N2)+A4×(g+h×N2)≤A3×(e+f×n2), the data transmission mode is determined as a compression mode.

In this embodiment, an optimal power consumption policy (the compression or non-compression mode) can be reasonably calculated at the gateway 11 in a data receiving stage of the terminal 12, so that the second data packet can be sent according to the optimal power consumption policy, and thus the power consumption of the terminal 12 receiving data can be reduced. In addition, by determining, based on the third data volume, the fourth data volume, a third average current used when the terminal 12 receives data, and a fourth average current used when the terminal 12 decompresses data, a comparison result of energy consumption between the terminal 12 receiving compressed data and the terminal 12 receiving non-compressed data, the data transmission mode can be determined more accurately, thereby achieving low power consumption of the terminal 12 when receiving data.

In some embodiments, the terminal 12 includes a communication module and a controller. In addition to the data transmission module and the first power determination module, the controller further includes a second power determination module.

The communication module is further configured to establish communicative connection with the gateway 11 in response to an instruction to establish connection with the gateway 11. This may specifically include sending an instruction to establish connection with the gateway 11 from the controller to the communication module via a bus, and requesting the communication module to establish communicative connection with the gateway 11. Further, the communication module is further configured to send the received gateway signal intensity and WiFi signal intensity to the second power determination module.

The gateway 11 is further configured to receive a communicative connection request, feed back the signal intensity of the gateway 11 and the WiFi signal intensity to the communication module. The gateway 11 can monitor a signal intensity RSSI_STA of the air WiFi signal (i.e., WiFi signal intensity) in real time. The signal intensity of the gateway 11 is a minimum RSSI (which may be understood as an antenna sensitivity S) of AP set at delivery, and denoted as RSSI_AP.

In the embodiments of the present application, a general purpose of WiFi transmission is to ensure the transmission efficiency, i.e., “acceptable packet loss (probability) rate”, and “sufficient bandwidth (network speed)”; and a higher signal intensity means higher transmission reliability, but also higher power consumption. The shielding, distance and even antenna angle between the AP and the STA may affect the WiFi signal intensity.

In an IoT 1AP+n×STA system architecture, the power consumption comes from three sources, a controller (MCU), a peripheral device, and a radio frequency IC, where a battery-powered or chargeable terminal STA is more sensitive to power consumption, and if the transmitting power of the terminal STA (or the radio frequency IC) can be reduced, the overall power consumption of the system will be reduced.

If the overall transmitting power of radio frequency IC in one terminal 12 is 0.5 w, the transmitting power is mainly generated by exciting corresponding electromagnetic waves in the radio frequency IC by current, and the electromagnetic wave intensity generated by the transmitting power of the radio frequency IC is described by I, where I is expressed as an average energy flow Poynting vector within one oscillation cycle, and calculated by: I=S̅=Average(E×B/μ₀), where B represents an magnetic induction intensity; E represents an electric field intensity, and S represents electromagnetic energy flowing per unit time through a unit area perpendicular thereto.

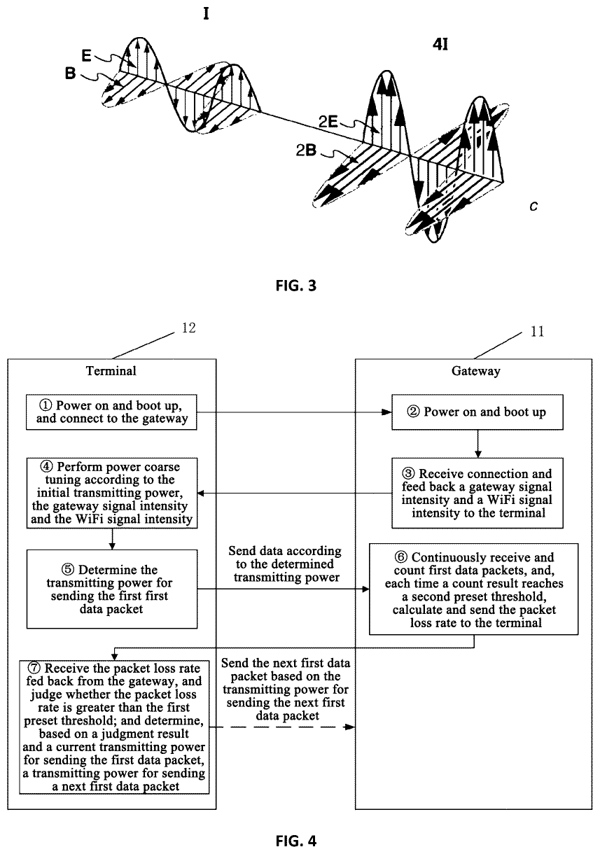

For the electromagnetic wave intensity I, E and B may be described by sine and cosine, and considering a mean value, the formula may be:

$$I = \frac{{E}^{2}}{2 {μ}_{0} c} = \frac{{cB}^{2}}{2 {μ}_{0}}$$

where μ₀ represents an air attenuation parameter; and c represents the speed of light. Assuming that the energy (the transmitting power of the radio frequency IC) is increased by four times, for example, a 0.5 W radio frequency IC is increased to 2 W, the amplitude of the air electromagnetic waves will be increased by two times, as shown in FIG. 3, which is a radiant energy diagram of the air electromagnetic waves.

In propagation, electromagnetic waves suffer energy loss, and I, S and E, B keep decaying, then how much loss is needed to become background white noise is related to the receiving sensitivity of the AP antenna. The receiving sensitivity of the antenna is described by the minimum intensity of the received electromagnetic waves (i.e., the minimum S described above), i.e., RSSI_AP. Then, the sensitivity of the antenna S=10lg(kTB)+NF+SNR, i.e.: the antenna receiving sensitivity S=10lg (thermal noise power over the bandwidth range)+system noise factor+signal-to-noise ratio required for demodulation, which is highly correlated with the electromagnetic environment.

Based on the above analysis, in the embodiments of the present disclosure, the initial transmitting power of the preset radio frequency IC is roughly adjusted in the power-on process of the terminal 12. Specifically, the second power determination module is configured to receive the gateway signal intensity and the WiFi signal intensity, and determine, based on a preset initial transmitting power, the gateway signal intensity, and the WiFi signal intensity, the transmitting power for the terminal 12 sending the first first data packet.

Illustratively, since the transmitting power is squared with the signal intensity, the transmitting power P₁ for the terminal 12 sending the first first data packet is determined by:

$${P}_{1} = {P}_{0} \times {( \frac{RSSI\_AP}{RSSI\_STA} )}^{2}$$

where P₁ represents the transmitting power for the terminal 12 sending the first first data packet; P₀ represents the initial transmitting power; RSSI_AP represents the gateway signal intensity; and RSSI_STA represents the WiFi signal intensity.

The calculation method used in this example enables the terminal 12 to be quickly brought into proximity of the optimal low power after power-on, thereby allowing the radio frequency IC to remain in an ideal low power consumption state once it starts to work.

Further illustratively, the transmitting power may be adjusted by a binary method. Specifically, after the terminal 12 is powered on and the boot time of the terminal 12 is not reached, the initial transmitting power for the terminal sending the first data packet is adjusted for multiple times, and each adjusted initial transmitting power is taken as the initial transmitting power for a next adjustment. When the boot time of the terminal 12 is reached, a latest adjusted initial transmitting power is taken as the transmitting power for the terminal 12 sending the first first data packet. Each adjustment of the initial transmitting power specifically includes: judging whether the WiFi signal intensity is greater than the gateway signal intensity; if the WiFi signal intensity is greater than the gateway signal intensity, adjusting the initial transmitting power according to a preset algorithm, so that the adjusted initial transmitting power is less than the initial transmitting power before adjustment; and if the WiFi signal intensity is less than or equal to the gateway signal intensity, taking a current initial transmitting power as the initial transmitting power for a next adjustment.

Here, the preset algorithm is, for example, expressed by the following binary formula:

$${P}_{1} = \frac{{P}_{2}}{2}$$

where P₁ represents the transmitting power for the terminal 12 sending the first first data packet; and P₂ represents the initial transmitting power.

Here, the boot time of the terminal 12 may refer to the shortest time from power-on to boot-up of the terminal 12; or an average time length from power-on to boot-up of the terminal 12 according to historical statistics.

The binary method in this example can more accurately locate the terminal 12 near the optimal low power level after power-on, thereby allowing the radio frequency IC to remain in the ideal low power consumption state once it starts to work.

In some embodiments, the power determination unit includes a first coarse tuning subunit and a second coarse tuning subunit. The first coarse tuning subunit is configured to determine a coarse power according to a correspondence relationship between transmitting powers and signal intensities, the preset initial transmitting power, the gateway signal intensity, and the WiFi signal intensity. The second coarse tuning subunit is configured to determine, according to a boot time of the terminal 12, the coarse power, the gateway signal intensity, and the WiFi signal intensity, the transmitting power for the terminal 12 sending the first first data packet. The boot time of the terminal 12 may refer to the shortest time from power-on to boot-up of the terminal 12; or an average time length from power-on boot-up of the terminal 12 according to historical statistics. The correspondence relationship between transmitting powers and signal intensities may be understood as a squared relationship. For example, when the transmitting power is increased by four times, the signal intensity is increased by two times.

The first coarse tuning subunit is configured to determine a specific coarse tuning process of power. Illustratively, since the transmitting power is squared with the signal intensity, the coarse power P₂ is determined by:

$${P}_{2} = {P}_{0} \times {( \frac{RSSI\_AP}{RSSI\_STA} )}^{2}$$

where P₂ represents the coarse power; P₀ represents the initial transmitting power; RSSI_AP represents the gateway signal intensity; and RSSI_STA represents the WiFi signal intensity.

The second coarse tuning subunit is configured to determine the transmitting power for the terminal 12 sending the first first data packet. Furthermore, the second coarse tuning subunit is specifically configured to: after the terminal 12 is powered on and the boot time of the terminal 12 is not reached, adjust the coarse power for multiple times, and take each adjusted coarse power as the coarse power for a next adjustment; and when the boot time of the terminal 12 is reached, take a latest adjusted coarse power as the transmitting power for the terminal 12 sending the first first data packet. Each adjustment of the coarse power specifically includes: judging whether the WiFi signal intensity is greater than the gateway signal intensity; if the WiFi signal intensity is greater than the gateway signal intensity, adjusting the coarse power according to a preset algorithm, so that the adjusted coarse power is less than the coarse power before adjustment; and if the WiFi signal intensity is less than or equal to the gateway signal intensity, taking a current coarse power as the coarse power for a next adjustment.

The preset algorithm is, for example, expressed by the following binary formula:

$${P}_{1} = \frac{{P}_{2}}{2}$$

where P₁ represents the transmitting power for the terminal 12 sending the first first data packet; and P₂ represents the coarse power.

The following describes, in a complete example, the dynamic adjustment of the power at which the terminal 12 sends data: FIG. 4 is a schematic diagram illustrating information interaction between a gateway 11 and a terminal 12 according to an embodiment of the present disclosure. As shown in FIG. 4, the information interaction between the gateway 11 and the terminal 12 includes a coarse tuning process of transmitting power and a fine tuning process of transmitting power. The coarse tuning process refers to a process of adjusting an initial transmitting power after the terminal 12 is powered on and the boot time of the terminal 12 is not reached, so as to determine the transmitting power for the terminal 12 sending a first first data packet. The fine tuning refers to a process of adjusting, based on a judgment result about whether the packet loss rate is greater than the first preset threshold, the current transmitting power for sending the first data packet when the boot time of the terminal 12 is reached, so as to determine a transmitting power for sending a next first data packet. The specific process includes: \textcircled{1} powering on and booting the terminal 12, and connecting the gateway 11; \textcircled{2} powering on and booting the gateway 11; \textcircled{3} receiving connection and feeding back a gateway signal intensity and a WiFi signal intensity to the terminal 12; \textcircled{4} performing power coarse tuning by the terminal 12 according to the initial transmitting power, the gateway signal intensity and the WiFi signal intensity (specifically referring to the coarse tuning process described above); \textcircled{5} determining the transmitting power for sending the first first data packet by the terminal 12, and sending data according to the determined transmitting power; \textcircled{6} continuously receiving and counting first data packets by the gateway 11, and, each time a count result reaches a second preset threshold, calculating and sending the packet loss rate to the terminal 12; and \textcircled{7} receiving, by the terminal 12, the packet loss rate fed back from the gateway 11, and judging whether the packet loss rate is greater than the first preset threshold; and determining, based on a judgment result and a current transmitting power for sending the first data packet, a transmitting power for sending a next first data packet, based on which a next first data packet is further sent.

In some embodiments, the IoT type WiFi module has two low power consumption sleep modes, i.e., a light sleep mode and a deep sleep mode, which have different levels of performance and power consumption. In the present disclosure, the power consumption of light sleep mode and the power consumption of the deep sleep mode in a sleep cycle are calculated in advance to determine a sleep mode of the sleep cycle to be entered by the terminal 12, thereby achieving low power consumption of the system.

Compared with a normal operation state (for example, in a data transceiving operation state), the terminal 12 in the light sleep state has lower power consumption, but also lower efficiency. In the deep sleep state, the terminal 12 has the lowest power consumption, but WiFi scanning needs to be performed again when reconnection is performed, which will increase the power consumption. Therefore, the present disclosure calculates the optimal power consumption policy by comprehensively considering various influence factors.

Specifically, the terminal 12 further includes a mode determination module. The mode determination module is configured to determine, within one sleep cycle according to a preset fifth average current in a light sleep mode, a preset sixth average current when the gateway 11 is scanned for connection, a preset seventh average current in a deep sleep mode, a duration of the sleep cycle, and a connection duration when the gateway 11 is scanned for connection, a sleep mode of the sleep cycle to be entered by the terminal 12 as a light sleep mode or a deep sleep mode; and enter a sleep state according to the determined sleep mode until a wakeup cycle begins. One wakeup cycle and one sleep cycle form one heartbeat cycle.

The fifth average current in the light sleep mode, the sixth average current when the gateway 11 is connected, and the seventh average current in the deep sleep mode are average parameters calculated in advance, and configured as fixed values to the terminal 12.

The duration of the sleep cycle is an interval between two heartbeats of the terminal 12, and since one heartbeat corresponds to one wakeup cycle, the interval between two heartbeats is also an interval between two wakeup cycles.

The actual connection duration of the terminal 12 scanning the gateway 11 for connection is different each time. Therefore, an average connection duration of scanning the gateway 11 for connection based on historical statistics may be calculated and configured as a fixed parameter to the terminal 12, and used as the connection duration of the terminal 12 scanning the gateway 11 for connection in a sleep mode pre-calculation stage. Alternatively, a latest connection duration of the terminal 12 performing WiFi scanning for connection may be used as the connection duration of the terminal 12 scanning the gateway 11 for connection in the pre-calculation stage.

Illustratively, the fifth average current of the terminal 12 in the light sleep mode is A5, which can be obtained through a fixed pattern test. The sixth average current of the terminal 12 performing WiFi scanning for connection is A6, which can be obtained through a fixed pattern test. The connection duration of the terminal 12 performing WiFi scanning for connection is t7. The seventh average current of terminal 12 in the deep sleep mode is A7, which can be obtained through a fixed pattern test. The duration of the terminal 12 in sleep without working within one heartbeat cycle (i.e., the duration of one sleep cycle) is t8. On this basis, the terminal 12 judges whether to enter the light sleep state or the deep sleep state each time before entering sleep. If the terminal 12 selects to enter the light sleep mode in the sleep cycle, the consumed energy is A5×t8. If the terminal 12 selects to enter the deep sleep mode in the sleep cycle, the consumed energy is (t8−t7)×A7+t7×A6. If A5×t8>(t8−t7)×A7+t7×A6, it is determined that the terminal 12 is to enter the deep sleep mode in the sleep cycle, and the duration of the sleep cycle to be entered is set to t8−t7. In contrast, if A5×t8≤(t8−t7)×A7+t7×A6, it is determined that the terminal 12 is to enter the light sleep mode in the sleep cycle.

In this embodiment, various influence factors are considered comprehensively to reasonably calculate an optimal power consumption policy (that is, a light sleep mode or a deep sleep mode) within one heartbeat cycle of the terminal 12 according to parameters such as a fifth average current of the terminal 12 in the light sleep mode, a sixth average current of the terminal 12 scanning the gateway 11 for connection, a seventh average current of the terminal in the deep sleep mode, a sleep cycle duration, and a connection duration of scanning the terminal 11 for connection, so that the terminal 12 can enter a sleep state according to the optimal power consumption policy, thereby reducing power consumption of the terminal 12 in the sleep state, and further reducing the power consumption of the system.

In some embodiments, the terminal 12 is further configured to be operated in the light sleep mode during the wakeup cycle until receiving or sending data according to a preset task in response to a data transceiving request.

In this embodiment, the operation state of the terminal 12 in the wakeup cycle is configured such that the terminal 12 keeps operating in the light sleep mode, thereby reducing the power consumption of the terminal 12.

Here, the preset task may further determine whether to compress the data packet in the process of receiving the second data packet or sending the first data packet by the terminal 12 in combination with the above embodiments, so as to determine a data transmission mode (a compression mode or a non-compression mode) with the optimal system low power consumption, thereby achieving low power consumption of the system.

In addition, the WiFi module adopted in the embodiments of the present disclosure may implement communication by the sixth generation wireless network technology WiFi6. In WiFi6, a TWT function is added, and in an adapted multi-terminal WiFi scenario, a broadcast mode of the TWT may be used. In other words, the AP and the STA execute a TWT protocol to mutually confirm a wakeup cycle (i.e., active time), and establish data connection in the wakeup cycle, while the STA sleeps at other time to maintain a low power consumption state.

However, the TWT in the existing art is significant in that reconnection is not needed upon wakeup from sleep, and a sleep mechanism is often designed for the current terminal 12, which allows the MCU and the WiFi IC to enter a sleep mode to reduce power consumption while not working. However, after the terminal is restarted, the WiFi terminal is used as a peripheral device to perform reconnection with the AP, that is, the processes of scanning, discovering, confirming the SSID, and the like, and the AP re-stores the terminal 12 in the routing table for data transmission, which involves additional power consumption.

In an IoT low power scenario, if the slot of the TWT is considered in the sleep mechanism of the terminal 12 to include the wakeup cycle of the terminal 12 in the working state of the terminal 12, the power consumption can be further reduced, and the data can be transmitted at any time when the terminal wakes up.

The most common application scenario of the TWT mechanism in the existing art is: the AP uniformly schedules the wakeup cycle of each terminal 12 according to the number of terminals 12, to avoid data collision in the air. However, since the working state of each terminal 12 is constantly adjusted, and it is often difficult to meet the requirement of low power consumption with a fixed wakeup cycle, an embodiment of the present disclosure further provides a scheme for calculating a next wakeup cycle of the terminal 12 based on a current transmitting power of the terminal 12, so that the terminal 12 enters the wakeup state according to the optimal wakeup cycle, thereby achieving low power consumption of the system. For example, the wakeup cycle is continuously updated (i.e., shortened), along with which the sleep cycle is increased within one heartbeat cycle, thereby reducing the power consumption of the terminal 12. In some embodiments, the gateway 11 is further configured to calculate wakeup cycles corresponding to different terminals 12 according to a preset algorithm.

Specifically, the gateway 11 is configured to configure wakeup cycles of a plurality of mounted terminals 12 of the same type, where the plurality of terminals 12 of the same type may be understood as terminals 12 performing the same or similar tasks.

Illustratively, the AP may have 100 mounted terminals 12 with the same function (for example, WiFi tags of a supermarket), and each terminal 12 may have a different lower limit of the transmitting power (or a stable transmitting power of the terminal 12) after the self-reduction of transmitting power as described in the above embodiment. Therefore, the AP may determine the data in the following table:

| | | Transmitting |
|---|---|---|
| No. | IP | Power (W) |
| 1 | 192.168.1.2 | 1 |
| 2 | 192.168.1.4 | 2 |
| 3 | 192.168.1.6 | 3 |

In this embodiment, to balance the power consumption of all the terminals 12, the frequency of wakeup cycles of the terminal 12 is lengthened, and it is assumed that the terminal 12 has an optimal working frequency F=X times/min, and a minimum frequency F=Y times/min. In this embodiment, a terminal 12 with the minimum power consumption is used as a reference, and to achieve the minimum consumption of the system, TWT wakeup is performed on each terminal 12 at Y times/min. Taking efficiency into consideration, the frequency of the target terminal 12 is F=X×Q1/Q, where Q1 represents a last updated transmitting power of terminal 12, and Q represents the stable transmitting power of terminal 12. If F is less than Y, take F=Y.

The application scenario of this function is: for a plurality of terminals 12 performing identical functions, a period with low WiFi power consumption occupies more slots to perform more functions, thereby reducing the overall power consumption. For example, in a supermarket scenario, a mosquito killer lamp and an illuminating lamp both need to acquire illumination intensity information, and if the mosquito killer lamp is used for acquiring data, the power is relatively high, leading to higher system energy consumption. Therefore, the sleep cycle of the mosquito killer lamp can be prolonged, while the wakeup cycle can be shortened.

The basic idea for realizing this function is: achieving data-saving on the terminal 12 side through more precise calculation at the gateway 11, including: maintaining a slot (wakeup cycle) table of the terminal 12 in the TWT protocol on the gateway 11 side in a format as follows:

| | | | | | | |
|---|---|---|---|---|---|---|
| Start | T1 | T2 | T3 | T4 | End | Idle/Sleep |

| | | | |
|---|---|---|---|
| Sn1 | Sn2 | Sn3 | Sn4 |

where Sn1, Sn2, Sn3 and Sn4 represent different terminals 12, respectively; and T1, T2, T3 and T4 represent wakeup cycles corresponding to different terminals 12, respectively.

In the existing TWT protocol, the slot table is only agreed at the start (hereinafter referred to as a “gateway (AP) command mode”), and the gateway 11 needs to calculate the next wakeup cycle for each terminal 12. Statistics may be performed with a physical model as follows:

| Task (Function) | Device available | Task cycle times/min |
|---|---|---|
| task1 | Sn1, Sn2 Sn3 | 2 |
| task2 | Sn3, Sn4 | 1 |
| task3 | Sn2 | 4 |

Then, the gateway (AP) will have at most four active slots per minute, which implement the functions of:

| Slot | 1 | 2 | 3 | 4 |
|---|---|---|---|---|
| Task | 1, 2, 3 | 3 | 2, 3 | 3 |

Needless to say, the power consumption for executing each task is different, and Wmin=ΣWmintaskn, which means that each task is completed by selecting the terminal 12 with the minimum power consumption. Therefore, a set of devices to be started during each slot is obtained:

| Slot | 1 | 2 | 3 | 4 |
|---|---|---|---|---|
| Device | Sn2, Sn3 | Sn2 | Sn2, Sn3 | Sn2 |

Therefore, the basis for the TWT adjusting the slots is obtained, and active devices in each active slot are specified accordingly. For example, if 100 supermarket tags have the function of testing the illumination intensity, and the illumination intensity in one area is consistent, the device with the minimum power consumption in the area can be selected to complete the task.

In some embodiments, in addition to the scheme for calculating a next wakeup cycle of the terminal 12 based on a current transmitting power of the terminal 12, different data volumes of transmitted by different terminals 12 in unit time can be used to allocate different wakeup cycles to the respective mounted terminals 12 of the gateway 11 to adapt to network communication of different terminals 12. For example, a terminal 12 sending a larger data volume may have more opportunities.

Specifically, the gateway 11 is further configured to determine a next wakeup cycle of the terminal 12 according to a data volume transmitted by the terminal 12 in unit time and a network speed of the terminal 12.

Most terminals 12 are required to have a function like real-time transmission, which is reflected on the slots (wakeup cycles) as all terminals 12 actively engaging in data communication in each slot (wakeup cycle). Therefore, the more precisely the time is allocated to the terminal 12 in each slot, the lower the power consumption of the terminal 12 will be.

The gateway 11 is configured to determine the next wakeup cycle T of the terminal 12 by:

$$T = \frac{M}{S}$$

where M represents the data volume transmitted by the terminal 12 in unit time, and S represents the network speed of the terminal 12. It should be noted that the data volume transmitted by the terminal 12 in unit time may be a parameter pre-configured to the gateway 11; or the gateway 11 may detect the data volume transmitted by each mounted terminal 12 in unit time.

Similarly, the next wakeup cycle T of each mounted terminal 12 (Sn) of the gateway 11 is determined as:

| | | | | | | |
|---|---|---|---|---|---|---|
| Slot | Sn1 | Sn2 | Sn3 | Sn4 | End | Idle |

| | | | | |
|---|---|---|---|---|
| T | M₁/S₁ | M₂/S₂ | M₃/S₃ | M₄/S₄ |

For example, if the data volume transmitted by the terminal 12 per minute is 60k, and the network speed is 1K/s, then the slot (wakeup cycle) of the terminal 12 per minute is 1s.

In this embodiment, based on the data volume transmitted by the terminal 12 in unit time and the network speed, the gateway 11 allocates an accurate wakeup cycle to each terminal 12 to enable minimum power consumption of each terminal 12.

In some embodiments, for some terminals 12 reporting data, frequent reporting is not needed in a stable environment. Illustratively, in a greenhouse where a temperature sensor is used to collect the room temperature, if the same reporting frequency is adopted for a time period with dramatic temperature changes and a stable time period, there will be resource waste, and the power consumption will be increased. On this basis, an embodiment of the present disclosure provides a scheme for calculating a next wakeup cycle of a terminal 12 based on a variation and a time difference in data transmission of the terminal 12, so that the terminal 12 enters the wakeup state according to the optimal wakeup cycle, thereby achieving low power consumption of the system.

Specifically, the gateway 11 is further configured to acquire a predefined minimum data variation in two adjacent transmissions by the terminal 12; and determine a next wakeup cycle of the terminal 12 based on the minimum data variation, an actual data variation between two adjacent transmissions by the terminal, and a time difference between two adjacent data transmissions.

Here, the minimum data variation δ is a predefined and allowable minimum data variation δ in two adjacent transmissions (reports) by the terminal 12. If a data variation between the data to be transmitted currently by the terminal 12 and the data transmitted last time by the terminal 12 is less than the minimum data variation δ, it indicates that the data collected by the terminal 12 does not need to be transmitted, so the terminal 12 may cancel this transmission, thereby reducing the power consumption.

The actual variation ΔR in the value of the data in two adjacent transmissions is a data variation (i.e., a difference in the value of data) between the data to be transmitted currently this time (or the data to be transmitted) and the data transmitted last time.

The gateway 11 is further configured to determine the next wakeup cycle T of the terminal 12 by:

$$T = \frac{δ}{L}$$

$$L = \frac{Δ R}{Δ T}$$

where δ represents the minimum data variation; and L represents a slope coefficient, i.e., a ratio of the time difference ΔT between two adjacent data transmissions to the actual data variation ΔR of the two adjacent data transmissions.

For example, when a temperature sensor is used to collect the room temperature, set δ=2 °C. If the room temperature changes by 1 °C while the temperature change time is 2 s, the actual temperature currently collected by the temperature sensor does not need to be reported; and in this case, L=1/2. Given a constant slope coefficient L, the next wakeup cycle of the terminal 12 is determined as T=2/L.

In this embodiment, the gateway 11 sets an accurate next wakeup cycle for the terminal 12 based on the variation in data volume and the time interval between two adjacent transmissions, so that a minimum power consumption of the terminal 12 is achieved.

In addition, an embodiment of the present disclosure further provides a low-power-consumption device interconnection method applied to a low-power-consumption device interconnection system. The low-power-consumption device interconnection system includes a gateway and a terminal. The method includes:
by the terminal, sending a first data packet to the gateway, receiving a packet loss rate fed back from the gateway, and judging whether the packet loss rate is greater than the first preset threshold; and determining, based on a judgment result and a current transmitting power for sending the first data packet, a transmitting power for sending a next first data packet.

It should be noted that for the execution process of the terminal, reference may be made to the specific embodiments of the terminal in the low-power-consumption device interconnection system described above, and repeated descriptions are omitted.

In this embodiment, the gateway receives and counts first data packets, and, each time a count result reaches a second preset threshold, calculates a packet loss rate and reset the count result; and sends the packet loss rate to the terminal.

It should be noted that for the process of executing the operations by the gateway, reference may be made to the specific embodiments of the gateway in the low-power-consumption device interconnection system described above, and repeated descriptions are omitted.

Therefore, the transmitting power of the terminal is dynamically adjusted at an application level (terminal) in the embodiments of the present disclosure, to ensure a continuous low-power-consumption state of the terminal. Specifically, the terminal judges whether to adjust its current transmitting power mainly by receiving a packet loss rate fed back from the gateway (i.e., a protocol layer). For example, in the case that the judgment result indicates a lower packet loss rate, the transmitting power can be appropriately reduced to reduce the system power consumption. In addition, the gateway may be configured to calculate the packet loss rate only when a certain number of first data packets have been received, so that unnecessary power consumption increased by frequently counting the packet loss rate is avoided, and thus, unnecessary power consumption increased by frequently adjusting the transmitting power is avoided.

In some embodiments, the terminal includes a communication module and a controller.

The communication module sends the received first data packet to the gateway; and receives the packet loss rate fed back from the gateway, and sends the packet loss rate to the controller; and receives a transmitting power to be configured to send a next first data packet according to the currently configured transmitting power.

It should be noted that for the process of executing the operations by the communication module, reference may be made to the specific embodiments of the communication module in the low-power-consumption device interconnection system described above, and repeated descriptions are omitted.

The controller sends a first data packet to be transmitted to the communication module; and receives the packet loss rate, and judges whether the packet loss rate is greater than the first preset threshold; and determines, based on a judgment result and a current transmitting power for sending the first data packet, a transmitting power for sending a next first data packet, and configures the transmitting power for sending the next first data packet to the communication module.

It should be noted that for the process of executing the operations by the controller, reference may be made to the specific embodiments of the controller in the low-power-consumption device interconnection system described above, and repeated descriptions are omitted.

In some embodiments, the controller includes a data transmission module and a first power determination module.

The data transmission module sends a first data packet to be transmitted to the communication module.

It should be noted that for the process of executing the operations by the data transmission module, reference may be made to the specific embodiments of the data transmission module in the low-power-consumption device interconnection system described above, and repeated descriptions are omitted.

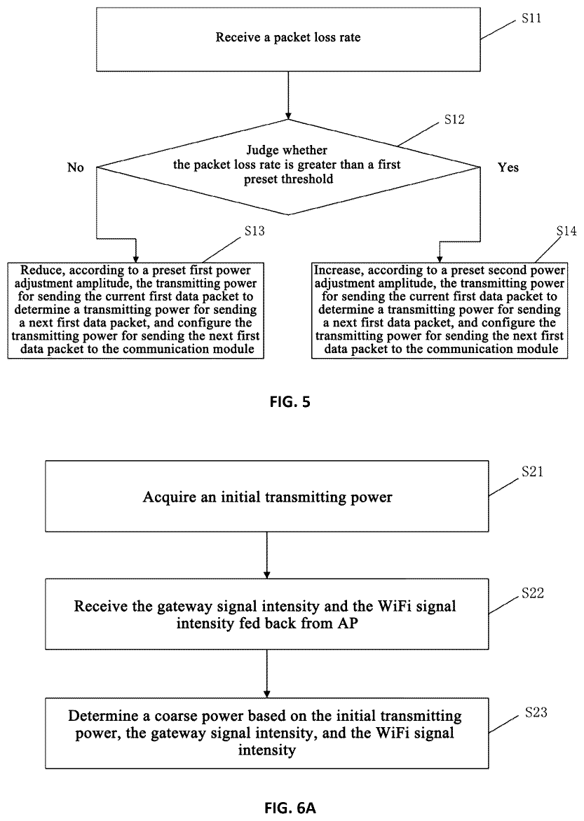

FIG. 5 is a flowchart of power fine tuning according to an embodiment of the present disclosure. As shown in FIG. 5, the executor is a first power determination module, and the process specifically includes steps S11 to S14.

S11 includes receiving a packet loss rate.

S12 includes judging whether the packet loss rate is greater than a first preset threshold; proceeding to step S13 under the condition that the packet loss rate is less than or equal to the first preset threshold; and proceeding to step S14 under the condition that the packet loss rate is greater than the first preset threshold.

S13 includes reducing, according to a preset first power adjustment amplitude, the transmitting power for sending the current first data packet to determine a transmitting power for sending a next first data packet, and configuring the transmitting power for sending the next first data packet to the communication module.

S14 includes increasing, according to a preset second power adjustment amplitude, the transmitting power for sending the current first data packet to determine a transmitting power for sending a next first data packet, and configuring the transmitting power for sending the next first data packet to the communication module.

It should be noted that for the process of executing the operations by the data transmission module, reference may be made to the specific embodiments of the data transmission module in the low-power-consumption device interconnection system described above, and repeated descriptions are omitted.

In some embodiments, the data transmission module specifically determines a data transmission mode in response to a data transmission request and according to a first data volume of the first data packet to be transmitted; and sends the first data packet according to the data transmission mode.

It should be noted that for the specific execution process of the data transmission module, reference may be made to the specific embodiments of the data transmission module in the low-power-consumption device interconnection system described above, and repeated descriptions are omitted.

In some embodiments, the data transmission module includes a mode determination unit and a data transmission unit. The mode determination unit determines, based on the first data volume of the first data packet, a second data volume of the first data packet after compression; determines a comparison result of energy consumption between compression transmission and non-compression transmission based on the first data volume, the second data volume, a first average current for non-compression transmission of the first data packet and a second average current for compression-transmission of the first data packet; and determines the data transmission mode to be a compression mode or a non-compression mode according to the comparison result. The data transmission unit sends the first data packet according to the determined data transmission mode, i.e., the compression mode or non-compression mode.

It should be noted that for the execution processes of the mode determination unit and the data transmission unit, reference may be made to the specific embodiments of the mode determination unit and the data transmission unit in the low-power-consumption device interconnection system described above, and repeated descriptions are omitted.

In some embodiments, the gateway further performs the following process: determining, based on a third data volume of a second data packet to be transmitted, a fourth data volume of the second data packet after compression; determining, based on the third data volume, the fourth data volume, a third average current when the terminal receives data, and a fourth average current when the terminal decompresses data, a comparison result of energy consumption between the terminal receiving compressed data and the terminal receiving non-compressed data; determining, according to a comparison result, whether the data transmission mode is a compression mode or a non-compression mode; and sending the second data packet to the terminal according to the determined data transmission mode, i.e., the compression mode or non-compression mode.

It should be noted that for the process of executing the operations by the gateway, reference may be made to the specific embodiments of the gateway in the low-power-consumption device interconnection system described above, and repeated descriptions are omitted.

In some embodiments, the terminal includes a communication module and a controller; and the controller includes a second power determination module.

The communication module establishes communicative connection with the gateway in response to an instruction to establish connection with the gateway; and sends the received gateway signal intensity and WiFi signal intensity to the second power determination module. The second power determination module receives the gateway signal intensity and the WiFi signal intensity, and determines, based on a preset initial transmitting power, the gateway signal intensity, and the WiFi signal intensity, the transmitting power for the terminal sending the first first data packet. The gateway receives a communicative connection, feeds back the gateway signal intensity and the WiFi signal intensity to the communication module.

In some embodiments, the second power determination unit includes a first coarse tuning subunit and a second coarse tuning subunit. The first coarse tuning subunit is configured to determine a coarse power according to a correspondence relationship between transmitting powers and signal intensities, the preset initial transmitting power, the gateway signal intensity, and the WiFi signal intensity.

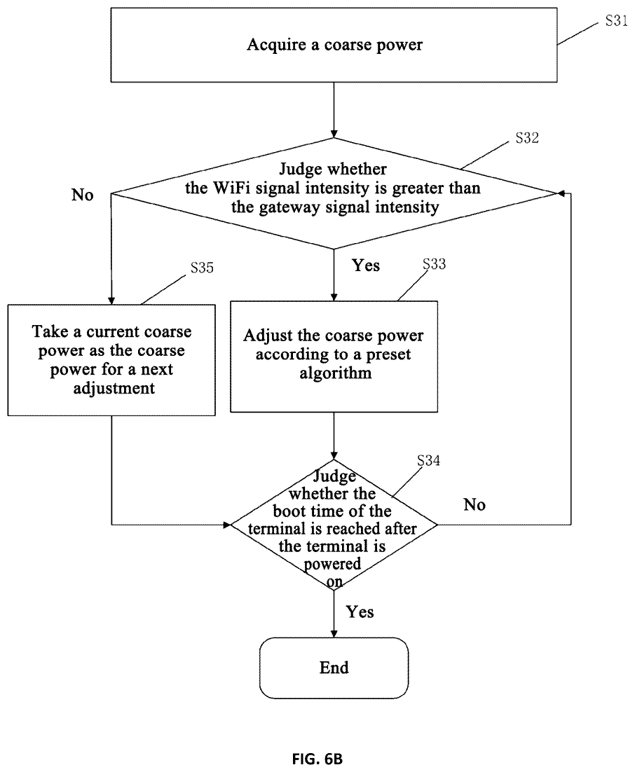

FIG. 6a is a flowchart illustrating a first step of power coarse tuning according to an embodiment of the present disclosure. As shown in FIG. 6a, the executor is the first coarse tuning subunit, and the process specifically includes the following steps S21 to S23.

S21 includes acquiring an initial transmitting power for the terminal sending the first data packet.

S22 includes receiving the gateway signal intensity and the WiFi signal intensity fed back from the gateway (AP).

S23 includes determining, based on the initial transmitting power, the gateway signal intensity, and the WiFi signal intensity, a coarse power for the terminal sending the first data packet.

Illustratively, since the transmitting power is squared with the signal intensity, the coarse power P₂ is determined by:

$${P}_{2} = {P}_{0} \times {( \frac{RSSI\_AP}{RSSI\_STA} )}^{2}$$

where P₂ represents the coarse power; P₀ represents the initial transmitting power; RSSI_AP represents the gateway signal intensity; and RSSI_STA represents the WiFi signal intensity.

The second coarse tuning subunit determines, according to a boot time of the terminal, the coarse power, the gateway signal intensity, and the WiFi signal intensity, the transmitting power for the terminal sending the first first data packet.

It should be noted that for the process of executing the operations by the second coarse tuning subunit, reference may be made to the specific embodiments of the second coarse tuning subunit in the low-power-consumption device interconnection system described above, and repeated descriptions are omitted.

In some embodiments, the second coarse tuning subunit specifically executes the following process: after the terminal is powered on and the boot time of the terminal is not reached, adjusting the coarse power for multiple times, and taking each adjusted coarse power as the coarse power for a next adjustment; and when the boot time of the terminal is reached, taking a latest adjusted coarse power as the transmitting power for the terminal sending the first first data packet.

Each adjustment of the coarse power specifically includes: judging whether the WiFi signal intensity is greater than the gateway signal intensity; if the WiFi signal intensity is greater than the gateway signal intensity, adjusting the coarse power according to a preset algorithm, so that the adjusted coarse power is less than the coarse power before adjustment; and if the WiFi signal intensity is less than or equal to the gateway signal intensity, taking a current coarse power as the coarse power for a next adjustment.

FIG. 6b is a flowchart illustrating a second step of power coarse tuning according to an embodiment of the present disclosure. As shown in FIG. 6b, the executor is the second coarse tuning subunit, and the process specifically includes steps S31 to S35.

S31 includes acquiring a coarse power.

S32 includes judging whether the WiFi signal intensity is greater than the gateway signal intensity; proceeding to step S33 if the WiFi signal intensity is greater than the gateway signal intensity; and proceeding to step S35 if the WiFi signal intensity is less than or equal to the gateway signal intensity.

S33 includes adjusting the coarse power according to a preset algorithm, so that the adjusted coarse power is less than the coarse power before adjustment.

S34 includes judging whether the boot time of the terminal is reached after the terminal is powered on; ending the process if the boot time of the terminal is reached; and returning to step S32 if the boot time of the terminal is not reached after the terminal is powered on.

S35 includes taking a current coarse power as the coarse power for a next adjustment, and proceeding to step S34; and if the boot time of the terminal is reached after the terminal is powered on at this time, taking a last adjusted coarse power as the transmitting power for the terminal sending the first first data packet.

In some embodiments, the terminal further includes a mode determination module; and one heartbeat cycle of the terminal includes one wakeup cycle and one sleep cycle. In response to an end of a wakeup cycle, the mode determination module determines, according to a preset fifth average current in a light sleep mode, a preset sixth average current when the gateway is scanned for connection, a preset seventh average current in a deep sleep mode, a duration of the sleep cycle, and a connection duration of the terminal scanning the gateway for connection, a sleep mode of the sleep cycle to be entered by the terminal as a light sleep mode or a deep sleep mode; and enters a sleep state according to the determined sleep mode until a wakeup cycle begins.

It should be noted that for the process of executing the operations by the mode determination module, reference may be made to the specific embodiments of the mode determination module in the low-power-consumption device interconnection system described above, and repeated descriptions are omitted.

In some embodiments, the terminal is operated in the light sleep mode during the wakeup cycle until receiving or sending data according to a preset task in response to a data transceiving request.

It should be noted that for the process of executing the operations by the terminal, reference may be made to the specific embodiments of the terminal regarding the wakeup cycle stage in the low-power-consumption device interconnection system described above, and repeated descriptions are omitted.

In some embodiments, the gateway calculates wakeup cycles corresponding to different terminals according to a preset algorithm.

In some embodiments, the gateway determines a next wakeup cycle of the terminal according to a data volume transmitted by the terminal in unit time and a network speed of the terminal.

It should be noted that for the execution process of the gateway determining the next wakeup cycle of the terminal, reference may be made to the specific embodiments of the gateway configured to determine a next wakeup cycle of the terminal according to a data volume transmitted by the terminal in unit time and a network speed of the terminal in the low-power-consumption device interconnection system described above, and repeated descriptions are omitted.

In some embodiments, the gateway acquires a predefined minimum data variation in two adjacent transmissions by the terminal; and determines a next wakeup cycle of the terminal based on the minimum data variation, an actual data variation between two adjacent transmissions by the terminal, and a time difference between two adjacent data transmissions.

It should be noted that for the execution process of the gateway determining the next wakeup cycle of the terminal, reference may be made to the specific embodiments of the gateway further configured to determines a next wakeup cycle of the terminal based on the minimum data variation, an actual data variation between two adjacent transmissions by the terminal, and a time difference between two adjacent data transmissions in the low-power-consumption device interconnection system described above, and repeated descriptions are omitted.

An embodiment of the present disclosure further provides a computer-readable non-transitory storage medium, the computer-readable non-transitory storage medium has a computer program stored thereon which, when executed by a processor, causes steps of any one of the low-power-consumption device interconnection methods described in the above embodiments to be implemented.

In particular, according to the embodiments of the present disclosure, the process described above with reference to the flowchart may be implemented as a computer software program. For example, an embodiment of the present disclosure includes a computer program product including a computer program embodied on a machine-readable medium, where the computer program contains a program code for performing the method illustrated by the flowchart. In such embodiments, the computer program may be downloaded and installed from a network through a communication part, and/or installed from a removable medium. The computer program, when executed by a central processing unit (CPU), causes the functions defined in the system of the present disclosure to be implemented.

It should be noted that the computer-readable non-transitory medium in the present disclosure may be a computer-readable signal medium or a computer-readable storage medium, or any combination of the two. For example, the computer-readable storage medium may be, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disc, a random access memory (RAM), a read-only memory (ROM), an erasable programmable read-only memory (EPROM or FLASH), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program for use by or in connection with an instruction execution system, apparatus, or device. In contrast, in the present disclosure, the computer-readable signal medium may include a propagated data signal with a computer-readable program code embodied therein, for example, in a baseband or as part of a carrier wave. Such a propagated data signal may take any of a variety of forms, including but not limited to, an electromagnetic signal, an optical signal, or any suitable combination thereof. The computer-readable signal medium may be any computer-readable non-transitory storage medium that is not a computer-readable storage medium, which can communicate, propagate, or transport a program for use by or in connection with an instruction execution system, apparatus, or device. The program code embodied on the computer-readable non-transitory storage medium may be transmitted by any appropriate medium, including but not limited to: wireless, electrical wires, optical cables, RF, and the like, or any suitable combination of the foregoing.

The flowchart and block diagrams in the figures illustrate the architecture, functionality, and operation of possible implementations of apparatuses, methods and computer program products according to various embodiments of the present disclosure. In this regard, each block in the flowchart or block diagram may represent a functional block, a program segment, or a portion of a code including one or more executable instructions for implementing the specified logical function(s). It should also be noted that, in some alternative implementations, the functions shown in the blocks may occur out of the order shown in the figures. For example, two blocks shown in succession may, in fact, be executed substantially concurrently, or may sometimes be executed in the reverse order, depending upon the functionality involved. It will also be noted that each block in the block diagram and/or flowchart, and combinations of blocks in the block diagram and/or flowchart, may be implemented by a special purpose hardware-based system which performs the specified functions or operations, or by combinations of special purpose hardware and computer instructions.

The circuits or subcircuits described in the embodiments of the present disclosure may be implemented by software or hardware. The described circuits or subcircuits may be provided in a processor, which may be described as: a processor, including: a receiving circuit and a processing circuit. The processing circuit includes a write subcircuit and a read subcircuit. The name of such a circuit or subcircuit does not constitute any limitation to the circuit or subcircuit itself in some cases. For example, the receiving circuit may also be described as “receiving a video signal”.

It will be appreciated that the above implementations are merely exemplary implementations for the purpose of illustrating the principle of the present disclosure, and the present disclosure is not limited thereto. Various modifications and improvements can be made by a person having ordinary skill in the art without departing from the spirit and essence of the disclosure. Accordingly, all of the modifications and improvements also fall within the protection scope of the present disclosure.

1. A low-power-consumption device interconnection system, comprising a gateway and a terminal, wherein
the terminal is configured to send a first data packet to the gateway, receive a packet loss rate fed back from the gateway, and judge whether the packet loss rate is greater than a first preset threshold; and determine, based on a judgment result and a current transmitting power for sending the first data packet, a transmitting power for sending a next first data packet; and
the gateway is configured to receive and count first data packets, and, each time a count result reaches a second preset threshold, calculate a packet loss rate and reset the count result; and send the packet loss rate to the terminal.

2. The low-power-consumption device interconnection system according to claim 1, wherein the terminal comprises a communication module and a controller;
the communication module is configured to send a first data packet received from the controller to the gateway; and receive the packet loss rate fed back from the gateway, and send the packet loss rate to the controller; receive a transmitting power to be configured for sending the first data packet, and send a next first data packet according to a currently configured transmitting power; and
the controller is configured to send a first data packet to be transmitted to the communication module; and receive the packet loss rate from the communication module, and judge whether the packet loss rate is greater than the first preset threshold; and determine, based on a judgment result and a current transmitting power for sending the first data packet, a transmitting power for sending a next first data packet, and configure the transmitting power for sending the next first data packet to the communication module.

3. The low-power-consumption device interconnection system according to claim 2, wherein the controller comprises a data transmission module and a first power determination module;
the data transmission module is configured to send a first data packet to be transmitted to the communication module; and
the first power determination module is configured to: receive the packet loss rate; under the condition that the packet loss rate is less than or equal to the first preset threshold, reduce, according to a preset first power adjustment amplitude, the transmitting power for sending the current first data packet to serve as the transmitting power for sending the next first data packet, and configure the transmitting power for sending the next first data packet to the communication module; and under the condition that the packet loss rate is greater than the preset threshold, increase, according to a preset second power adjustment amplitude, the transmitting power for sending the current first data packet to serve as the transmitting power for sending the next first data packet, and configure the transmitting power for sending the next first data packet to the communication module.

4. The low-power-consumption device interconnection system according to claim 3, wherein the data transmission module is further configured to: determine a data transmission mode in response to a data transmission request and according to a first data volume of the first data packet to be transmitted; and send the first data packet according to the determined data transmission mode.

5. The low-power-consumption device interconnection system according to claim 4, wherein the data transmission module comprises a mode determination unit and a data transmission unit;
the mode determination unit is configured to: determine, based on the first data volume of the first data packet, a second data volume of the first data packet after compression; determine a comparison result of energy consumption between compression transmission and non-compression transmission based on the first data volume, the second data volume, a first average current for non-compression transmission of the first data packet and a second average current for compression-transmission of the first data packet; and determine the data transmission mode to be a compression mode or a non-compression mode according to the comparison result; and
the data transmission unit is configured to send the first data packet according to the determined data transmission mode.

6. The low-power-consumption device interconnection system according to claim 5, wherein the energy consumption for the compression transmission is A1×(a+b×N1)+A2×(c+d×n1), and the energy consumption for the non-compression transmission is A1×(a+b×n1), where A1 represents the first average current for non-compression transmission of the first data packet, A2 represents the second average current for compressing the first data packet, n1 represents the first data volume, (a+b×n1) represents transmission time for the non-compressed first data packet, (a+b×N1) represents transmission time for the compressed first data packet, N1 represents the second data volume, (c+d×n1) represents time for compressing the first data packet, and a, b, c, and d are preset coefficients, and wherein
the mode determination unit is further configured to: under the condition that energy consumption A1×(a+b×N1)+A2×(c+d×n1) for the compression transmission is greater than energy consumption A1×(a+b×n1) for the non-compression transmission, determine the transmission mode to be a non-compression mode; and under the condition that energy consumption A1×(a+b×N1)+A2×(c+d×n1) for the compression transmission is not greater than energy consumption A1×(a+b×n1) for the non-compression transmission, determine the transmission mode to be a compression mode.

7. The low-power-consumption device interconnection system according to claim 1, wherein the gateway is further configured to: determine, based on a third data volume of a second data packet to be transmitted, a fourth data volume of the second data packet after compression; determine, based on the third data volume, the fourth data volume, a third average current when the terminal receives data, and a fourth average current when the terminal decompresses data, a comparison result of energy consumption between the terminal receiving compressed data and the terminal receiving non-compressed data; determine the data transmission mode to be a compression mode or a non-compression mode based on the comparison result; and send the second data packet to the terminal according to the determined data transmission mode.

8. The low-power-consumption device interconnection system according to claim 7, wherein the energy consumption for the terminal receiving compressed data is A3×(e+f×N2)+A4×(g+h×N2), and the energy consumption for the terminal receiving non-compressed data is A3×(e+f×n2), where A3 represents the third average current when the terminal receives data, A4 represents the fourth average current when the terminal decompresses data, n2 represents the third data volume, N2 represents the fourth data volume, (e+f×N2) represents time for the terminal receiving data, (g+h×N2) represents time for the terminal decompressing data, (e+f×n2) represents time for the terminal receiving data, and e, f, g, and h represent preset parameters, and wherein
the gateway is further configured to: under the condition that the energy consumption A3×(e+f×N2)+A4×(g+h×N2) for the terminal receiving compressed data is greater than the energy consumption A3×(e+f×n2) for the terminal receiving non-compressed data, determine the data transmission mode to be a non-compression mode; and under the condition that the energy consumption A3×(e+f×N2)+A4×(g+h×N2) for the terminal receiving compressed data is not greater than the energy consumption A3×(e+f×n2) for the terminal receiving non-compressed data, determine the data transmission mode to be a compression mode.

9. The low-power-consumption device interconnection system according to claim 1, wherein the terminal comprises a communication module and a controller; the controller further comprises a second power determination module;
the communication module is configured to: establish communicative connection with the gateway in response to an instruction to establish connection with the gateway; and send the received gateway signal intensity and WiFi signal intensity to the second power determination module;
the second power determination module is configured to: receive the gateway signal intensity and the WiFi signal intensity, and determine, based on a preset initial transmitting power, the gateway signal intensity, and the WiFi signal intensity, a transmitting power for the terminal sending a first first data packet; and
the gateway is further configured to receive a communicative connection request, send an instruction to establish the connection to the communication module, and feed back the gateway signal intensity and the WiFi signal intensity to the communication module.

10. The low-power-consumption device interconnection system according to claim 9, wherein the second power determination unit comprises a first coarse tuning subunit and a second coarse tuning subunit;
the first coarse tuning subunit is configured to determine a coarse power for the terminal sending the first data packet according to a correspondence relationship between transmitting powers and signal intensities of the terminal for sending the first data packet, the preset initial transmitting power for the terminal sending the first data packet, the gateway signal intensity, and the WiFi signal intensity; and
the second coarse tuning subunit is configured to determine, according to a boot time of the terminal, the coarse power for the terminal sending the first data packet, the gateway signal intensity, and the WiFi signal intensity, a transmitting power for the terminal sending a first first data packet.

11. The low-power-consumption device interconnection system according to claim 10, wherein the second coarse tuning subunit determines the coarse power for the terminal sending the first first data packet by:
$${P}_{1} = {P}_{0} \times {( \frac{RSSI\_AP}{RSSI\_STA} )}^{2}$$
where P₁ represents the transmitting power for the terminal sending the first first data packet; P₀ represents the initial transmitting power for the terminal sending the first data packet; RSSI_AP represents the gateway signal intensity; and RSSI_STA represents the WiFi signal intensity.

12. The low-power-consumption device interconnection system according to claim 10, wherein the second coarse tuning subunit determines the transmitting power for the terminal sending the first first data packet by:
$${P}_{1} = \frac{{P}_{2}}{2}$$
where P₁ represents the transmitting power for the terminal sending the first first data packet; and P₂ represents the coarse power.

13. The low-power-consumption device interconnection system according to claim 10, wherein the second coarse tuning subunit is further configured to: after the terminal is powered on and the boot time of the terminal is not reached, adjust the coarse power for the terminal sending the first data packet for multiple times, and take each adjusted coarse power for the terminal sending the first data packet as the coarse power to be adjusted for the terminal sending the first data packet; when the boot time of the terminal is reached, take a last adjusted coarse power for the terminal sending the first data packet as the transmitting power for the terminal sending the first first data packet; and
wherein the second coarse tuning subunit is further configured to: judge, in each adjustment of the coarse power, whether the WiFi signal intensity is greater than the gateway signal intensity; if the WiFi signal intensity is greater than the gateway signal intensity, adjust the coarse power of the first data packet sent from the terminal according to a preset algorithm, so that the adjusted coarse power of the first data packet sent from the terminal is less than the coarse power of the first data packet sent from the terminal before adjustment; and if the WiFi signal intensity is less than or equal to the gateway signal intensity, take a current coarse power for the terminal sending the first data packet as the coarse power to be adjusted for the terminal sending the first data packet.

14. The low-power-consumption device interconnection system according to claim 1, wherein the terminal further comprises a mode determination module; and one heartbeat cycle of the terminal comprises one wakeup cycle and one sleep cycle; and
the mode determination module is configured to: in response to an end of a wakeup cycle, determine, according to a preset fifth average current in a light sleep mode, a preset sixth average current when the gateway is scanned for connection, a preset seventh average current in a deep sleep mode, a duration of the sleep cycle, and a connection duration of the terminal scanning the gateway for connection, a sleep mode of a sleep cycle to be entered by the terminal as a light sleep mode or a deep sleep mode; and enter a sleep state according to the determined sleep mode until a wakeup cycle begins.

15. The low-power-consumption device interconnection system according to claim 14, wherein energy consumption for the terminal entering light sleep is A5×t8, and energy consumption for the terminal entering deep sleep is (t8−t7)×A7+t7×A6, where A5 represents the preset fifth average current in the light sleep mode, A6 represents the preset sixth average current when the gateway is scanned for connection, A7 represents the preset seventh average current in the deep sleep mode, t8 represents the duration of the sleep cycle, and t7 represents the connection duration of the terminal scanning the gateway for connection, and wherein
the mode determination module is further configured to: under the condition that the energy consumption A5×t8 for the terminal entering the light sleep is greater than the energy consumption (t8−t7)×A7+t7×A6 for the terminal entering the deep sleep, determine that the terminal enters the deep sleep mode; and under the condition that the energy consumption A5×t8 for the terminal entering the light sleep is not greater than the energy consumption (t8−t7)×A7+t7×A6 for the terminal entering the deep sleep, determine that the terminal enters the light sleep mode.

16. The low-power-consumption device interconnection system according to claim 14, wherein the terminal is further configured to be operated in the light sleep mode during the wakeup cycle until receiving or sending data according to a preset task in response to a data transceiving request.

17. The low-power-consumption device interconnection system according to claim 14, wherein the gateway is further configured to determine a next wakeup cycle of the terminal according to a data volume transmitted by the terminal in unit time and a network speed of the terminal.

18. The low-power-consumption device interconnection system according to claim 1, wherein the gateway is further configured to: acquire a predefined minimum data variation in two adjacent transmissions by the terminal; and determine a next wakeup cycle of the terminal based on the minimum data variation, an actual data variation between two adjacent transmissions by the terminal, and a time difference between two adjacent data transmissions.

19. A low-power-consumption device interconnection method applied to a low-power-consumption device interconnection system, wherein the low-power-consumption device interconnection system comprises a gateway and a terminal; and the low-power-consumption device interconnection method comprises:
by the terminal, sending a first data packet to the gateway, receiving a packet loss rate fed back from the gateway, and judging whether the packet loss rate is greater than the first preset threshold; and determining, based on a judgment result and a current transmitting power for sending the first data packet, a transmitting power for sending a next first data packet; and
by the gateway, receiving and counting first data packets, and, each time a count result reaches a second preset threshold, calculating a packet loss rate and resetting the count result; and sending the packet loss rate to the terminal.

20. A computer-readable non-transitory storage medium, wherein the computer-readable non-transitory storage medium has a computer program stored thereon which, when executed by a processor, cause steps of the low-power-consumption device interconnection method according to claim 19 to be implemented.
